(19) United States
(12) Patent Application Publication
(10) Pub. No.: US 2016/0007645 A1
(43) Pub. Date: Jan. 14, 2016

(54) FOOD PACKAGED IN HARD CONTAINER, AND METHOD FOR PRODUCING SAME

(71) Applicants: CHRISTAR CORPORATION, Fuchu-shi, Hiroshima (JP); HIROSHIMA PREFECTURE, Hiroshima-shi, Hiroshima (JP)

(72) Inventors: Koji SAKAMOTO, Hiroshima-Shi (JP); Kenya SHIBATA, Hiroshima-Shi (JP); Fumihiko TOYOTA, Fukuyama-Shi (JP)

(73) Assignees: HIROSHIMA PREFECTURE, Hiroshima-shi, Hiroshima-ken (JP); CHRISTAR CORPORATION, Fuchu-shi, Hiroshima-ken (JP)

(21) Appl. No.: 14/649,627

(22) PCT Filed: Aug. 13, 2013
(86) PCT No.: PCT/JP2013/071875

§ 371 Date: Jun. 4, 2015

(30) Foreign Application Priority Data
Dec. 4, 2012 (JP) 2012-265691
Feb. 23, 2013 (JP) 2013-033979

(51) Int. Cl. A23L 3/3571; B65D 81/24; B65D 81/28; A23L 3/10

(52) U.S. Cl. CPC A23L 3/3571; A23L 3/10; B65D 81/24; B65D 81/28; A23V 2002/00

(57) ABSTRACT

In a state where food ingredients, degradative enzymes, and liquid seasonings are housed and sealed in a hard vessel, it has become possible to develop food products packaged in the hard vessel for normal temperature distribution or chilled distribution by a method of carrying out all of the steps inside the hard vessel, which method comprises carrying out an enzyme impregnation step and an enzymatic reaction step by heating and carrying out an enzyme deactivation step and sterilization step by continuous heating; or by a method of carrying out, after introducing the degradative enzyme into the food ingredient, some steps of enzymatic reaction step, enzyme deactivation step, and sterilization step inside the hard vessel.

### BACKGROUND OF THE INVENTION

1. Field of the Invention

The present invention relates to food products packaged in a hard vessel and methods of production thereof. More particularly, the present invention relates to food products packaged in a hard vessel for normal temperature distribution or chilled distribution which prevents losing shape in a production step or during transportation, which food products have adjusted hardness while retain the original shape of food ingredient; and methods of producing such food products. The present invention has allowed for low cost, hygienic production of softened food products with their shape being retained while preventing losing shape by carrying out enzyme impregnation, enzymatic reaction, enzyme deactivation, pasteurization at low temperatures, or retort sterilization in a hard vessel; or by subjecting food ingredients to enzyme impregnation by pressure and placing the food ingredients in vessel before softening by enzymatic reaction, and carrying out the enzymatic reaction, enzyme deactivation, pasteurization at low temperatures, and retort sterilization in a hard vessel. Further, the invention has prevented food ingredients from losing their shape due to vibration at time of production or distribution, which has allowed for normal temperature distribution or chilled distribution without losing shape.

2. Background Art

As inventions of introducing enzymes to the inside of food ingredient, there are a method comprising freezing to loosen food ingredients and then rapidly impregnating enzymes by a depressurization or pressurization operation; a method of impregnating enzymes into heated food ingredients by pressure; a method comprising heating with saturated water vapor and then impregnating enzymes by depressurization; a method comprising subjecting in advance to animal food ingredients to steam heating or the like to loosen tissues and then rapidly impregnating enzymes by a depressurization operation. Also known are methods of introducing enzymes by physical impact or injection using specialized apparatus such as tumbling or injection method. Theses use a vacuum can or vacuum cooling machine, or a vacuum packaging machine and introduce enzymes by a pressure apparatus using hydrostatic pressure, a vacuum tumbler, or an injector apparatus. All of those are methods of introducing the enzyme to the inside of the food ingredient; and the food ingredient can be processed to be softened while retaining its shape by those enzyme impregnation techniques. However, because of their softness, these softened food ingredients are prone to lose their shape in production steps, for example, during heating, flavoring, packing into vessels, packaging, movement, or transportation; or while handled in retail suppliers, resulting in loss of product's characteristic shape in appearance or appetizing appearance. In particular, in the production step, for the purpose of preventing losing shape after enzymatic softening, the softened food ingredient is required to be frozen after the softening by the enzyme and packed into a vessel or packaged. Or a method of distributing products as frozen goods is employed for distribution as well.

What have thus far been shown are a method of rapidly introducing enzymes into tissues of vegetable food materials (Patent Document 1), a method comprising immersing frozen and thawed vegetable food products in an enzyme liquid with adjusted concentration of salt content of liquid seasoning or the like; introducing enzymes into tissues by a depressurization operation; and carrying out seasoning and retort sterilization without losing shape (Patent Document 2). Patent Document 1 relates to a method of rapidly introducing enzymes; and there is no mention of production of shape retaining softened food ingredients. On the other hand, Patent Document 2 relates to a method of producing pouch-packed food products concerning shape retaining softened food ingredients; and it describes an invention for preventing the food product from losing its shape in a retort (sterilization by applying pressure and heat) step. There is no mention at all with regard to losing shape in handling and during transportation of the softened food ingredient in production steps, retail stores selling, or the like. That is, the invention is an invention comprising adding dietary sodium chloride at 4 to 5% as a method of preventing losing shape in a retort step and cannot prevent the losing shape in handling and during transportation in the production step, and in physical handling in retail stores. Paragraph (0006) of Patent Document 2 describes a method of maintaining softness before autoclave processing. In addition, as described in the examples (0018) and (0023), after depressurization processing and enzymatic treatment, food ingredients are transferred to a film for retort and subjected to retort processing. Because such a method is not a method comprising carrying out the steps from an enzymatic reaction to a sealing step in a hard vessel, extremely careful handling is essentially required such that the food ingredient does not lose its shape after softened.

Also known is a method of producing prepared food products (Patent Document 3), which method allows this enzyme introduction technique to be simply and conveniently carried out on site such as kitchen facilities and can prevent softened food materials from losing their shape in production steps, during transportation in distribution process; or allows the steps of enzyme introduction into food materials, enzymatic reaction, and heating to be carried out in the same packaging vessel in consideration of hygienic aspects. Further, a method of depressurization processing in an enzyme liquid after heating in saturated water vapor (Patent Document 4) and the like are disclosed as well. In all of those methods, the enzyme and the like are introduced to the inside of the food ingredient using external pressure such as depressurization or pressurization.

As for animal food materials, what have been proposed are a method of immersing food materials in an enzyme liquid (Patent Document 5), a method of injecting an enzyme-containing liquid to food materials, followed by tumbling (Patent Document 6), a method of penetrating enzymes into food materials by applying an enzyme liquid to the food material or immersing the food material in an enzyme liquid, followed by vacuum packaging or pressurization processing (Patent Document 7), and the like.

As an invention concerning diets for examination using medical contrast agents, there is an invention in which enzyme and contrast agent are introduced to the inside of food ingredients by depressurization method (Patent Document 8). This also uses external pressure and does not take losing shape after production into consideration.

All of these are methods for introducing an enzyme liquid and seasoning to the inside of the food ingredient, and use physical mechanical apparatus such as depressurization apparatus or pressurization apparatus, injection apparatus, or tumbling apparatus. By these enzyme impregnation techniques, food products for persons having difficulty in chewing and swallowing can be produced, which food products retain their shape and are for maintaining health of persons in need of care and improving the quality of their life. The most important issue in production of this food product is how the product is produced and distributed at low cost. In particular, a method capable of preventing the product from losing its shape and allowing for normal temperature distribution or chilled distribution is demanded. Frozen goods require high production cost and distribution cost, which leads to an undeniable impression that the product price is high. Further, softening processing by enzymatic treatment can soften edible portions in particular in fish and shellfish, but cannot soften the bones to tenderness enough to be eaten. There are complaints about the bones as foreign particles and concerns on safety as the food product for persons having difficulty in chewing and swallowing. On the other hand, use of raw materials with the bones being removed for solving the problem leads to increase in the price, which hampers the supply of the product at an inexpensive price.

In the documents other than Patent Document 3, external pressure processing is carried out in an open system. On the other hand, in Patent Document 3, enzyme introduction and enzymatic reaction are carried out in a soft packaging vessel. In that document, the use of external energy is a premise for the pressure processing and the use of soft packaging materials are therefore essential. The soft packaging material has a weakness for physical impact from the outside. For that reason, the product loses its shape unless distributed as a frozen food product, which has been problematic. No prior art documents describe an invention concerning methods of carrying out an enzymatic reaction in a hard vessel.

Patent Document 9 describes a method comprising filling deli food materials along with liquid seasoning in a heat resistant vessel and subjecting the resulting mixture to heat sterilization. In the method, flavoring and sterilization are carried out at the same time in the heat resistant vessel while original textures are retained. An object and effect are different from those of the present invention which aims at carrying out an enzymatic reaction in a vessel to change textures. Further, Patent Document 10 describes a method of solidifying, using jellies, food ingredients that are softened by enzymes. It is a method of producing jellied food products, which method is characterized in that the product has properties that are solid enough to cut together with jellies in a unified fashion and thus hard vessels or the like are not required. Patent Document 11 describes a patent in which thickeners are introduced to the inside of softened food ingredients for the purpose of preventing separation of water out of the food ingredients such that persons having difficulty in chewing and swallowing are able to take. That is not an invention of preventing the food ingredient from losing its shape including its outer portion by vibration as described in the present invention.

### PRIOR ART REFERENCES

### Patent Documents

Patent Document 1:Japanese Patent Publication No. 3686912

Patent Document 2:Japanese Patent Application Laid-Open Publication No. 2006-223122

Patent Document 3:Japanese Patent Application Laid-Open Publication No. 2008-11794

Patent Document 4:Japanese Patent Application Laid-Open Publication No. 2010-115164

Patent Document 5:Japanese Patent Application Laid-Open Publication No. 1995-31421

Patent Document 6:Japanese Patent Application Laid-Open Publication No. 2005-503172

Patent Document 7:Japanese Patent Application Laid-Open Publication No. 2004-89181

Patent Document 8:Japanese Patent Application Laid-Open Publication No. 2007-204413

Patent Document 9:Japanese Patent Application Laid-Open Publication No. 1984-154946

Patent Document 10: Japanese Patent Application Laid-Open Publication No. 2011-193803

Patent Document 11: Japanese Patent Application Laid-Open Publication No. 2007-252323

### SUMMARY OF THE INVENTION

### Problems to be Solved by the Invention

An object of the present invention is to solve food products allowing for prevention of losing shape in production steps, during transportation, when sold in retail stores, in shape-retaining softened diets for persons in need of care, baby foods, the field of medicine, the field of diets for examination with medical contrast agents; and further allowing for normal temperature distribution or chilled distribution; and methods of producing such food products. Another object of the invention is to produce food products by introducing, without damaging the original shape of food product, degradative enzymes, taste components such as seasonings, fats and oils, or amino acids, and thickening agents which are necessary for dysphagia diets into the inside of food ingredients to change textures and tastes, which food products are inexpensive, are easy to eat, exhibit a very pleasant taste, and are for normal temperature distribution or chilled distribution. In addition, another object of the invention is to provide methods of producing food ingredients for normal temperature distribution or chilled distribution, the methods comprising introducing degradative enzymes to the center portion of the food ingredient, which method are capable of producing softened food products at low cost while retaining the original shape of the food ingredient such that persons in need of care and the elderly are able to recognize what food product they are eating and take in the food product with a feeling of satisfaction. Further, another object of the invention is to provide methods of producing food products for normal temperature distribution or chilled distribution, which food products are fortified with nutrient components or calories that are essential to persons in need of care and the elderly.

In the conventional process where enzymes are introduced to the inside of food ingredients by using energy from pressure and extremely soft food ingredients are produced and sold, extremely careful handling is required in order to prevent the food ingredient from losing its shape when subjected to an enzymatic reaction step, a packaging step, a transportation step. Because of that, the product needs to be, after enzyme deactivation, handled in a frozen state. Pouch-packed food products that are softened by enzyme treatment while retaining their shape and allowed for normal temperature distribution are being marketed. In this case, from the viewpoint of prevention of losing shape, it has been impossible to design products that have softness suitable for persons having difficulty in chewing and swallowing. In addition, in the softened food product produced by enzyme treatment, because the bones in fish and shellfish cannot be softened by enzymes and raw materials with the bones being removed are used, the following problems have arisen: the types of food ingredients that can be used are limited; fine bones are, if left, considered as foreign particles and complaints against that may be filed; and use of raw materials that have been processed for removing the bones is assumed for granted, which leads to high cost.

### Means for Solving the Problems

The present inventors found that the problems could be solved by adopting a method of producing canned food products as a method that allows, at the same time, prevention of losing shape in production and sales processes of enzyme softened food products, and a form allowing for normal temperature distribution or chilled distribution. By carrying out all steps of enzyme impregnation step, enzymatic reaction step, enzyme deactivation step, and sterilization step, or some steps of enzymatic reaction step, enzyme deactivation step, and sterilization step in a metallic canning or bottling vessel, workability between the steps can be improved, and shape-retaining softened food products for normal temperature distribution that are inexpensive and hygienically immersed in enzymes can be produced. In addition, because the food ingredient is placed in a distribution vessel in production steps, the shape is not lost and there is no need for the food ingredient itself to be transferred, which greatly reduces the production cost. The inventors found that, for retaining the shape of the food ingredient in a vessel and having an extreme soft state with a hardness of 5×10⁴ N/m² or less to prevent accidental swallowing-induced injury, a vacuum sealing method and pressurized sealing method are appropriate as a procedure of applying degradative enzymes and thickeners to the inside of the food ingredient as uniformly as possible. Further, the inventors found that, as for fish and shellfish, not only edible portions but also even the bones can be softened to a level suitable for persons having difficulty in chewing and swallowing while retaining the shape. Based on such findings, the present invention has been completed.

According to the present invention, the following inventions (1) to (20) are provided.

(1) A food product packaged in a hard vessel for normal temperature distribution or chilled distribution comprising a hard vessel; and a food ingredient, a degradative enzyme, and a liquid seasoning housed in the hard vessel;
wherein the food product is obtained by reacting the food ingredient with the degradative enzyme in the hard vessel to soften the food ingredient while retaining an original shape.

(2) The food product packaged in a hard vessel according to (1), wherein the degradative enzyme has an enzyme activity breaking down at least one kind of substrate selected from the group consisting of: carbohydrates, proteins, and lipids.

(3) The food product packaged in a hard vessel according to (1) or (2), wherein the hardness of softened food ingredient while retaining the original shape is 1.0×10² N/m² or more and 1.0×10⁷ N/m² or less.

(4) The food product packaged in a hard vessel according to any of (1) to (3), wherein liquid in the hard vessel is, when measured by a B type viscometer at 20° C., has a viscosity of 5 mPa·s or more and 20 Pa·s or less in a sol state with fluidity or in a gel state.

(5) The food product packaged in a hard vessel according to any of (1) to (4), wherein the liquid seasoning contains at least one kind selected from the group consisting of: dietary sodium chloride, amino acids, fats and oils, thickeners, medical contrast agents, sugars, sodium hydrogen carbonate, vitamins, and minerals.

(6) The food product packaged in a hard vessel according to any of (1) to (5), wherein the liquid seasoning is adjusted to a range of pH 3 to pH 10 by using an organic acid and a salt thereof.

(7) The food product packaged in a hard vessel according to any of (1) to (6), wherein the hard vessel is at least one kind selected from the group consisting of: metallic cans, bottles, and heat resistant formed vessels.

(8) A method of producing a food product packaged in a hard vessel for normal temperature distribution or chilled distribution in which a softened food ingredient while retaining an original shape is housed, the method comprising the steps of:
adding a food ingredient and a degradative enzyme-containing liquid into a hard vessel;
sealing the hard vessel;
increasing the temperature in the hard vessel after the sealing;
wherein an enzymatic reaction step, an enzyme deactivation step and a sterilization step are carried out inside the hard vessel under a series of temperature increase.

(9) A method of producing a food product packaged in a hard vessel for normal temperature distribution or chilled distribution in which a softened food ingredient while retaining an original shape is housed, the method comprising the steps of:
reacting a food ingredient with a degradative enzyme;
adding the food ingredient reacted with the degradative enzyme in a hard vessel;
increasing the temperature in the hard vessel;
wherein an enzymatic reaction step, an enzyme deactivation step and a sterilization step are carried out inside the hard vessel under a series of temperature increase.

(10) The method of producing a food product packaged in a hard vessel according to (8) or (9), the temperature of the enzymatic reaction step is in a range of 0° C. to 70° C. and the temperature of the sterilization step is in a range of 85° C. to 135° C.

(11) The method of producing a food product packaged in a hard vessel according to (9), wherein the hard vessel is sealed before the enzymatic reaction step or before the enzyme deactivation.

(12) The method of producing a food product packaged in a hard vessel according to (11), wherein pressurization processing or depressurization processing for the food ingredient is carried out before the sealing step of the hard vessel.

(13) The method of producing a food product packaged in a hard vessel according to any of (8) to (12), wherein the degradative enzyme has an enzyme activity of breaking down at least one kind of substrate selected from the group consisting of: carbohydrates, proteins, and lipids.

(14) The method of producing a food product packaged in a hard vessel according to any of (8) to (13), wherein a liquid seasoning is added into the hard vessel before the hard vessel is sealed.

(15) The method of producing a food product packaged in a hard vessel according to (14), wherein liquid in the hard vessel after the sterilization step has, when measured by a B type viscometer at 20° C., a viscosity of 5 mPa·s or more and 20 Pa·s or less in a sol state with fluidity or is in a gel state.

(16) The method of producing a food product packaged in a hard vessel according to (14) or (15), wherein the liquid seasoning contains at least one kind selected from the group consisting of: dietary sodium chloride, amino acids, fats and oils, thickeners, medical contrast agents, sugars, sodium hydrogen carbonate, vitamins, and minerals.

(17) The method of producing a food product packaged in a hard vessel according to any of (14) to (16), wherein the liquid seasoning is adjusted to a range of pH 3 to pH 10 by using an organic acid and a salt thereof.

(18) The method of producing a food product packaged in a hard vessel according to any of (8) to (17), wherein the pressure in the hard vessel after the sealing is changed by, before the sealing of the hard vessel, adding a gas component in a liquid or gaseous state to increase pressure after the sealing inside the hard vessel, or by degassing air in the hard vessel to reduce the pressure in the hard vessel after the sealing.

(19) The method of producing a food product packaged in a hard vessel according to any of (8) to (18), wherein the hardness of the softened food ingredient while retaining an original shape is 1.0×10² N/m² or more and 1.0×10⁷ N/m² or less

(20) The method of producing a food product packaged in a hard vessel according to any of (8) to (19), wherein the hard vessel is at least one kind selected from the group consisting of: metallic cans, bottles, and heat resistant formed vessels.

Examples of inventions in which all steps of enzyme impregnation step, enzymatic reaction step, enzyme deactivation step, and sterilization step are carried out in a bottle or can include the following method. Degradative enzymes and seasonings adhered on the surface of food ingredients or food ingredients immersed in an enzyme liquid containing pH adjusters, seasonings, or the like are placed in a hard vessel; and all steps of enzyme impregnation step, enzymatic reaction step, enzyme deactivation step, and sterilization step are carried out in the hard vessel. The characteristics of the present invention include use of pressure change in a bottling or canning vessel as energy of enzyme impregnation without use of energy such as external pressure in the enzyme impregnation step.

To be specific, food ingredients to be softened are first immersed in, sprayed with, or applied with an enzyme liquid; and thereby degradative enzymes are adhered to the surface of the food ingredient and then sealed in a hard vessel. At this time, the same sealing method as used for common canned products can be employed to seal the hard vessel. That is, methods comprising filling fully with food ingredients that have been applied with an enzyme liquid, or food ingredients and an enzyme liquid and sealing the vessel may be employed; or a vacuum double seam mode or high vacuum can mode comprising vacuum (depressurization) processing in the hard vessel at the time of the sealing may be employed. Alternatively, gases can be filled or sodium hydrogen carbonate can be added at the time of the sealing to carry out pressurized sealing. Thereafter, the temperature is slowly increased from a low temperature or normal temperature to, in the end, a retort sterilization temperature by heating. During that period of time, the food ingredient becomes swollen or steam is generated in the canning vessel to increase inner pressure; and therefore the enzymes and seasonings near the surface gradually penetrate into the food ingredients by pressure, adsorption, and osmotic pressure effects and at last the enzymes and seasonings are spread the whole of the food ingredients. A small amount of liquid nitrogen can be added at the time of the sealing to further increase the inner pressure.

Employment of high vacuum can produce a synergic effect of enzyme impregnation by depressurization processing at the time of sealing, and effective penetration of the enzyme to the central portion of food ingredient by inner pressure at low temperatures due to decrease in saturated water vapor pressure in the vessel in association with depressurization sealing.

At the time of temperature increase, the enzymatic reaction continues in a temperature zone where enzyme activities remain and the food ingredients are softened. In a hard vessel, physical pressure is applied from the outside to the inside and therefore the shape is retained. When the temperature is further increased and passes the denaturation temperature of enzyme proteins (for example, 70° C. to 100° C.), the enzymes are deactivated; and microorganisms are partially sterilized. When the temperature is further increased and becomes above 110° C., spore-forming bacteria begin to die, and retort sterilization is completed by applying pressure heating at a high temperature of about 120° C. for a certain period of time. A sterilization temperature may be 100° C. or less and, in that case, the product is a chilled-type bottled or canned food product. During this period of time, the food ingredients are softened while retaining their shape, normal temperature distribution or chilled-type, shape-retaining softened food ingredients can be efficiently, hygienically, and inexpensively produced.

Hardness control is determined by a rate of temperature increase, enzyme concentration, heating time, and a rate of cooling. The rate of temperature increase can be freely changed. That is, in the present invention, enzyme impregnation is carried out by using pressure change in the bottle or can, and enzymatic reaction, enzyme deactivation, and sterilization are carried out by continuously heating the food ingredients in the vessel; and therefore low cost, prevention of losing shape, hygiene, and normal temperature distribution can be all achieved.

Examples of inventions in which some steps of enzymatic reaction step, enzyme deactivation step, and sterilization step are carried out in a hard vessel include the following method. What has also been made is an invention capable of preventing losing shape in production steps, during transportation, in retail stores handling by applying an external pressure energy such as pressurization or depressurization to food ingredients and then placing the resultant in a bottling or canning vessel before the food ingredients are softened, followed by enzymatic reaction, enzyme deactivation, and sterilization steps in the bottling and canning vessel. This method produces an effect whereby a softening state can be visually seen. That is, in cases where some steps of enzymatic reaction step, enzyme deactivation step, and sterilization step are carried out in the hard vessel, the enzymatic reaction step, the enzyme deactivation step, and the sterilization step are carried out after the food ingredients that have in advance been subjected to enzyme impregnation by a method of pressurization, depressurization, or the like are placed in the hard vessel; or after the enzyme impregnation is carried out in the hard vessel by a method of pressurization, depressurization, or the like. The hard vessel can be sealed before the enzymatic reaction or after the enzymatic reaction. Even after the enzyme deactivation step, the food ingredients can be transferred to the hard vessel and care is required for handling because the food ingredients have been softened. In this case, the enzyme impregnation must be in advance carried out after the sealing; but because seasonings and thickeners can be added before or after the enzymatic reaction, there is a characteristic in that flavor, viscosity, and hardness are easy to be adjusted as appropriate. The temperature increase of the bottling or canning vessel can be carried out either under a sealed state or in an open state, and is preferably carried out before the enzymatic reaction step from the viewpoint of hygienic aspects. As for each on the conditions for temperature increase, optimal conditions in each of the enzymatic reaction, enzyme deactivation, and sterilization steps can be selected.

### Effect of the Invention

The present invention produces the following effects.

The present invention is a technology that is able to provide diets for persons in need of care, which diets have the same outer appearance as usual meals that are commonly provided. From the viewpoint of a fact that the elderly having decreased capability of chewing or swallowing and healthy general public can take meals that have different hardness but have the same outer appearance, the technique allows to “barrier-free food” to be provided in practice. In addition, by employing a canning step or bottling step, the food products can be distributed at a normal temperature and characterized by being hard to be losing the shape, albeit extremely soft food ingredient whose shape is retained, in production steps, packaging steps, during transportation, and in retail stores handling, characteristics of which are different from those of methods of producing conventional shape-retaining softened food ingredients that are assumed for granted to be necessary to be frozen or have improved workability by carrying out enzyme and liquid seasoning formulation, impregnation, deactivation in a soft packaging material. On the top of that, the steps from the enzymatic reaction to the sterilization can be inexpensively and hygienically carried out in a canning or bottling vessel. Unlike frozen goods, the product does not require frozen transportation or frozen storage, and can be stored for a long period of time without spending a cost for frozen storage. The product can be inexpensively and simply handled not only in a food product manufacturing industry but also in a kitchen in hospitals and nursing-care facilities, restaurants, and at home. As a result, the product produces a high effect of stimulating appetite for persons having difficulty in chewing and persons having difficulty in swallowing; and because the invention make the product easy to be purchased or cooked, it has a high effect in terms of the extent of contribution to society.

Further, as a noteworthy technique, shape-retaining softening techniques that have been thus far reported, which techniques use degradative enzymes, were not able to soften the bones of fish and shellfish. The bones have been known to be softened by pressure processing; but it is not practical, from the viewpoint of shape-retaining, to transfer food ingredients that have been subjected to enzyme impregnation, enzymatic reaction, and enzyme deactivation to a heat-resistant vessel for processing. Meanwhile, as for shape-retaining softened food products prepared by carrying out a series of steps up to heat enzyme deactivation in a soft packaging material, it is theoretically possible to soften the bones by using a pressure resistant soft packaging material but the shape cannot be for sure retained during distribution after autoclaving. The present invention has allowed for production of shape-retaining softened food products that can be distributed and stored at normal temperatures, wherein not only the meat of fish and shellfish but also even the bones are softened while the shape is retained.

The product of the present invention allows for normal temperature distribution and thereby is very effective as diets for persons in need of care, emergency food for the time of natural disaster, or stockpiles. When the off the Pacific coast of Tohoku Earthquake occurred, essential utilities such as electricity, gas, or water service were stopped; and there were some cases where frozen goods that are assumed for granted to be stored in a frozen state and dried products that require water when used were not able to be used. In particular, soft stockpile nonperishable products for persons having difficulty in chewing and swallowing, weanling babies, and the elderly are not widely available, leaving choices of meal limited; and they have a very hard time. The product of the present invention can be always kept as emergency foods at the time of disaster or stockpile food products, which is the only way to make it possible to provide delicious meals to those disadvantaged persons having difficulty in chewing and swallowing.

### DETAILED DESCRIPTION OF THE INVENTION

The method of producing shape-retaining softened food products allowing for normal temperature distribution or chilled distribution of the present invention is characterized by carrying out, in a hard vessel, all steps or some steps: an enzyme impregnation step of having degradative enzymes or seasonings contained uniformly in the inside of food ingredients; an enzymatic reaction step of breaking down enzyme substrates contained in the food ingredients by the action of the degradative enzymes while retaining the shape of the food ingredients; an enzyme deactivation step of deactivating the enzymes immediately once intended hardness is attained; and a retort sterilization step. The use of some of the steps refers to a case in which the hard vessel is used in the step after the enzymatic reaction step or later; and it is required to separately carry out the enzyme impregnation step in advance and having the enzyme penetrated into the inside of the food ingredients by depressurization or pressurization. It is necessary to carry out sealing of the hard vessel at any point between the steps; and the sealing at least prior to retort sterilization allows for characteristic normal temperature distribution. The difference between pouch-packed food products and chilled food products is determined by a sterilization temperature of the hard vessel.

The hard vessel used in the present invention is a vessel capable of preventing contents from losing their shape even when pressure is applied from the outside; and examples thereof include metallic cans, bottles, and heat resistance formed vessels. The heat resistant formed vessel can be used in replacement of the metallic can or bottle if it is for example a packaging vessel with a high barrier and is composed of plastic materials or, in the case of opaque packaging vessels, barrier materials such as aluminum foil, wherein examples of the plastic material include PP (polypropylene) which exhibits heat resistance and is inexpensive; NY (nylon) which imparts strength; EVOH (ethylene/vinyl alcohol copolymer resin), PET (polyethylene terephthalate) with SiOₓ vapor deposition or aluminum vapor deposition, and PVDC (polyvinylidene chloride) which function as the barrier material. In this case, plastic materials having a high adhesion ability such as polyethylene are used for a sealer part of lid. As for the lid, soft packaging materials can be used. The shape and material of the vessel are not limited as long as the vessel is a hard vessel capable of keeping the shape of content without great deformation even when pressure is physically applied from the outside, in particular, from side or bottom directions.

As the food ingredient used in the method of producing shape-retaining soft food product of the present invention, either vegetable food ingredients or animal food ingredients may be used. To be specific, examples of the vegetable food ingredient can include vegetables such as daikon white radish, carrot, burdock, bamboo shoot, cabbage, Chinese cabbage, celery, asparagus, spinach, komatsuna Japanese mustard spinach, bok-choy, or tomato; potatoes such as potato, sweet potato, or sato-imo potato; beans such as soybean, red bean, broad bean, or green pea; cereal crops such as rice, wheat or barley, Japanese barnyard millet, or foxtail millet; fruits such as apple, or peach; mushrooms such as shiitake mushroom, shimeji mushroom, enoki mushroom, nameko mushroom, matsutake mushroom; and seaweeds such as wakame seaweed, kombu kelp, or hijiki seaweed. Further, examples of the animal food ingredient can include, in addition to beef, pork, chicken, meats such as mutton, horse meat, venison, wild boar meat, goat meat, rabbit meat, or whale meat, or guts thereof; fishes such as horse mackerel, sweetfish, sardine, bonito, salmon, mackerel, or tuna, shellfishes such as abalone, oyster, scallop, clam, and other seafoods such as shrimp or prawn, crab, squid, octopus, or sea cucumber. In addition, products made from surimi seafood paste such as kamaboko fishcake, meat products such as ham or sausage, noodles, processed food products such as tsukemono pickled vegetables may be used. The food ingredient is not limited to these as long as it is an edible raw material or material for production of food products.

These food ingredients may be used in a raw state or may be heated and cooked, for example, simmered, grilled, steamed, deep-fried, or the like, to be used. Microwave oven heating or superheated steam treatment may be used as well. In addition, saturated water steam heating may also be used. A temperature at the time of heating is not particular limited, and is 60° C. or more for the purpose of denaturing endogenous proteins. Preferably, 65° C. or more is desirable. In high temperature processing such as baking, a heating temperature and a heating time need to be determined with consideration for deterioration of qualities such as color or aroma by heating. In addition, these food ingredients that are frozen or frozen and thawed can also be used. In addition, the food ingredients may be used after subjected to pretreatment such as boiling in an aqueous solution prepared by dissolving with dietary sodium chloride or organic acids such as citric acid and salts thereof. Further, for the purpose of facilitating degradative enzymes to penetrate into the inside, an apparatus for puncturing meat with needles such as a meat tenderizer can be used; or a method of partially pressing meat with roller or the like can be carried out.

The form of the food ingredient may be in any form of a lump or a bite size. The size of the food ingredient can be appropriately selected and the original shape of the food ingredient must be kept. The shape must be a shape that one can figure out what the material is. It must make the mouth of persons with difficulty in chewing and swallowing water. The food ingredient subjected to the present invention is preferably a lump of food ingredient having a thickness of 5 mm or more and a volume of 500 mm³ or more; but this shall not apply to molded products, noodles, green vegetables, beans, and the like.

As for the degradative enzyme used in the present invention, any degradative enzyme can be used as long as it is a degradative enzyme for proteins, carbohydrates, or fats; and can be appropriately selected in accordance with conditions of persons who take in food, enzyme substrates contained in the used food ingredient, and the like. Mainly, enzymes with enzymatic activities of any of pectinase, amylase, protease, glucanase, and cellulase are used. Specific examples thereof include enzymes that break down proteins to amino acids and peptides such as protease or peptidase; enzymes that break down plysaccharides such as starch, cellulose, inulin, glucomannan, xylan, alginic acid, or fucoidan to oligosaccharides or monosaccharides such as amylase, glucanase, cellulase, pectinase, pectin esterase, hemicellulase, β-glucosidase, mannase, xylanase, alginate lyase, chitosanase, inulinase, chitinase; and enzymes that degrades fats such as lipase. Each of these can be used solely; or two or more kinds of these can be used in combination as far as they do not inhibit each other. In particular, in cases where animal food ingredients are used as food ingredients, their taste can be improved by using protease or peptidase to yield amino acids or peptides. In addition, for the purpose of changing textures for the better, transglutaminase or the like can also be used. The origin of these degradative enzymes are not limited; and enzymes derived from plants, those derived from animals, or those derived from microorganisms can be used. The form of the degradative enzyme may be a powder or liquid; or an enzyme that is contained in a dispersion liquid may be used.

As for the above degradative enzyme liquid, in the case of liquid degradative enzyme formulations, they can used as they are or after diluted; and in the case of powdered degradative enzyme formulations, the degradative enzyme can be used in a state where it is dissolved in or dispersed to a solute such as water. The pH of the degradative enzyme liquid is preferably in a range of pH 3 to pH 10 and more preferably pH 4 to pH 8. Before the degradative enzyme liquid is used, the pH can be adjusted to the optimum pH of an enzyme with high enzyme activities or can be adjusted to the same pH as that of the food ingredient. For the adjustment of the pH of the degradative enzyme liquid, pH adjusters or the like such as organic acids such as citric acid, or salts or phosphates thereof can be used; or liquid seasonings whose pH is adjusted or the like can be used as well.

The amount of degradative enzyme used can vary depending on a heating rate or heating conditions of the hard vessel. The amount of degradative enzyme used can be appropriately selected according to an extent of softening and a level of generation of taste components. In cases where the degradative enzyme is used, examples include a range of 0.001 to 1.0 g based on 100 g of the food ingredient. In the case of the degradative enzyme liquid, the degradative enzyme can be used by dissolving in or dispersing to a solvent liquid in a range of 0.01 to 3.0% by mass.

As for seasonings added to the food ingredient, dietary sodium chloride, sugars, organic acids and salts thereof, thickeners such as polysaccharide thickeners can be added. Besides, nutrients and the like can be added. By using gums such as starch, curdlan, agar, guar gum, or xanthane gum; or thickeners such as pectin or carboxymethyl cellulose, separation of water from food products at the time of chewing can be inhibited, resulting in suitable food ingredients for persons having difficulty in swallowing. As for methods of using thickeners, the thickener can be dissolved in water; but, in cases where the thickener is added concurrently with the enzyme, desirable is, for the purpose of avoiding enzymatic hydrolysis and decreased effects of enzyme impregnation due to viscosity, a method of impregnating the enzyme alone, wherein the thickener is not dissolved in water and used in a dispersion state; and the thickener and the enzyme are impregnated into the food ingredient and then heated to turn into a sol and a gel, resulting in a gel state which is a state where the thickener is not combined with an enzyme liquid. Therefore, it is more preferred that the liquid seasoning before sealing of the hard vessel have contents that more readily dispersed or a lower viscosity. The viscosity is, when measured suing a B type rotational viscometer (manufactured by TOKYO KEIKI INC.) at 20° C., preferably 200 mPa·s or less, more preferably 20 mPa·s or less, still more preferably 1 mPa·s or more and 5 mPa·s or less. Further, the thickener functions as a buffer material for the food ingredients in the hard vessel and thereby helps prevent the food ingredients from losing their shape. In addition, edible oil with viscosity can be used as a material with a buffering action. In that case, a suitable viscosity of liquid in the hard vessel after the sterilization step is, when measured using a B type rotational viscometer (manufactured by TOKYO KEIKI INC.) at 20° C., preferably 5 mPa·s or more and 20 Pa·s or less in a sol state with fluidity, more preferably 100 mPa·s or more and 10 Pa·s or less, and still more preferably 300 mPa·s or more and 1 Pa·s or less. Regulating the viscosity of the liquid seasoning in the hard vessel within the above range is more useful for ease of eating for persons who take in food, easy takeoff from the vessel, prevention of the food ingredient from losing its shape. Note that the viscosity condition is not limited to this; and the liquid seasoning according to a state of vibration or conditions of persons who take in food may be prepared. Further, a state of the thickener at 20° C. may be in a gel state. When taken out from the vessel, the product may in some cases be easy to lose its shape. Thus, use of vessels allowing the product to be readily taken out is desirable.

Further, in addition to these substances, substances that increase nutritional values such as sugars, fats and oils, vitamins, minerals can be used as substances added to the food ingredient. As the sugar, in addition to monosaccharides, preferred are sugar alcohols such as sorbitol or xylitol; and disaccharides such as maltose or trehalose. In particular, fats and oils are effective for fortifying calories; and fats and oils can be emulsified to use and thereby increase the concentration introduced into the food ingredient to obtain high calorie food products.

In the case of meat and fish and shellfish, protease is used as a degradative enzyme; and lipase can be added to break down fats and oils and thereby change textures, taste, or the like. In addition, in this case, the softening effect can be further enhanced by carrying out in advance tumbling or puncturing with needles.

As for the substance added to the inside of the hard vessel, contrast agents, in addition to the above, can be added. In this case, the product can be used as diets for contrast examination of swallowing or digestive tract. As medical contrast agents used for the diet for medical examination of the present invention, suitable are medical contrast agents capable of enhancing the contrast by active energy ray radiation from medical projection apparatus such as x-ray photography, CT, MRI, or PET. Specific examples of such medical contrast agents can include iopamidol, Visipaque, iohexol, ioversol, iomeprol, iopromide, ioxilan, iotrolan, amidotrizoic acid, meglumine iothalamate, iotalamic acid, ioxaglic acid, meglumine iotroxate, ethyl ester of iodinated poppy-seed oil fatty acid, iopanoic acid, amidotrizoic acid, barium sulfate, gadopentetate dimeglumine, gadoteridol, ammonium ferric citrate, and ferumoxides. The content of the medical contrast agent depends on the types of food ingredients and food materials; and the content of the contrast agent in an enzyme liquid placed in a vessel can be set to, for example, 10 to 60 g and preferably 30 to 50 g based on 100 g of the food ingredient.

As for metallic cans used, vessels used for common canned food products can be used; and suitable are, in addition to those made of tinplate or steel, those made of aluminum. For the purpose of corrosion protection, it is possible to use vessels whose inner surface is coated or to wrap with parchment paper for sealing. As for bottles, heat resistant bottles with a metallic lid are appropriate.

As methods of carrying out all steps of enzyme impregnation step, enzymatic reaction step, enzyme deactivation step, and sterilization step in a hard vessel, food ingredients and degradative enzyme agents or an enzyme liquid thereof are placed in a hard vessel, and, in addition to those, if necessary, seasonings, thickeners, dietary sodium chloride, amino acids, fats and oils, or emulsified fats and oils, thickeners, sugars, or nutrient components such as vitamins and minerals are selected as appropriate and placed in the hard vessel, followed by adjustment of the pH, control of the viscosity, or the like. After the sealing, the temperature of the food ingredient is increased to promote swelling of the food ingredient. In this process, pressure in a can increases; and enzyme impregnation and enzymatic reaction proceed.

Before sealing a bottled or canned product, gas components such as nitrogen, air, or carbon dioxide can be added in a liquid or gaseous state immediately before the sealing to increase pressure in the can at time of enzyme impregnation step. In this case, it is preferred to use an inert gas which has a low reactivity such as nitrogen for enhancing the quality including antioxidation. Further, sodium hydrogen carbonate can also be used to increase the pressure in the vessel.

At the time of sealing a bottled or canned product, if a manufacturing process involving depressurization bottling, vacuum double seam, or high vacuum canning is employed, enzyme impregnation by depressurization at the time of the sealing and enzyme penetration effects associated with an increase in inner pressure by heating in a depressurized state can be synergistically achieved. The pressure in a can at the time of this sealing may be 90 kPa or less. More effects can be attained at a setting of 50 kPa or less. Higher effects are exerted preferably at a pressure of 30 kPa or less and more preferably 20 kPa or less.

Heating is feasible starting from any temperature; and a starting product temperature may be low temperatures equal to or lower than 10° C. or normal temperature. As the temperature increases, steam pressure increases; and because of swelling effects of the food ingredient, the inner pressure also increases. Due to the effects of pressure, adsorption, and osmotic pressure, an enzyme liquid and the like penetrate into the inside of the food ingredient and, at the same time, an enzymatic reaction proceeds. This period corresponds to an enzyme impregnation step and an enzymatic reaction step. If the food ingredient slowly passes through a temperature zone up to normal temperature preferably at 0.1° C./min to 10° C./min and more preferably at 0.1° C./min to 5° C./min, the food ingredient can undergo gently and uniformly the enzymatic reaction and become softened. If the temperature is increased at 10° C./min or more, the softening takes place; but if the transit time is short the food ingredient is hard to soften.

The enzymatic reaction is preferably carried out at 0 to 70° C. and can be more preferably carried out at 30 to 65° C. At 50 to 65° C., a rate of enzyme penetration and a rate of enzymatic hydrolysis can be increased in association with inner pressure. Therefore, a rate of temperature increase, retention temperature time, and the like are required to be set in accordance with an intended hardness and an acceptable range of variability of hardness. If a product temperature exceeds 70° C., most of the enzyme agents move forward to an enzyme deactivation step. To increase the temperature as quickly as possible after this step leads to cost reduction, quality and stabilization of hardness.

Starting at 65° C., the enzyme is partially deactivated; and microorganisms start dying. In the case of food ingredients with pH 4.5 or less, commercial sterilization is completed at approximately 85° C. In the case of retort sterilization, once the temperature exceeds 110° C. spore-forming bacteria start dying; and the retort sterilization is completed by applying pressure and heating at a high temperature of preferably 110° C. to 135° C., more preferably 115° C. to 125° C. for a certain period of time. Because all of the steps are carried out in the hard vessel, the sterilization is carried out at low cost and in a hygienic fashion and hardly causes losing shape. Note that, by subjecting the vessel after the retort sterilization to a cooling step by air cooling or water cooling, variability of hardness between lots can be inhibited.

As methods of carrying out some steps of enzymatic reaction step, enzyme deactivation step, and retort sterilization step in a hard vessel, food ingredients subjected to enzyme impregnation by a method such as pressurization or depressurization or food ingredients impregnated with enzymes and, at the same time, secondary materials such as seasonings, thickeners, sugars, and emulsified fats and oils are required to be in advance provided by separately using a processing apparatus. For the purpose of placing the food ingredient in a vessel with retaining its shape and without losing its shape, it is preferred that the food ingredient in a solid state, which is an early stage of enzymatic reaction, be placed in the vessel; but the food ingredient can be placed a hard vessel anytime at any stage as long as it is placed there without losing its shape. The method of enzyme impregnation is preferably a method comprising immersing in a degradative enzyme-containing liquid or spraying an degradative enzyme-containing liquid; a method of pressure processing comprising immersing in a degradative enzyme liquid, taking out of the enzyme liquid, and carrying out pressure processing; or the like; but the method is not limited to these methods as far as the enzyme is adhered to the surface of the food ingredient. Thereafter, the enzymatic reaction step, the enzyme deactivation step, and the sterilization step are carried out. The hard vessel is sealed before the enzymatic reaction or after the enzymatic reaction. The sealing may also be carried out even after the enzyme deactivation step; but because the food ingredient is softened and is easy to lose its shape, the sealing is more preferably carried out before the enzymatic reaction for hygienic processing. The pressure processing of the bottling or canning vessel before the sealing varies depending on the concentration of enzyme; and in cases where the enzyme liquid contains enzymes at 0.2%, the pressure is, when applied, preferably 1 MPa to 100 MP and more preferably 10 MPa to 20 MPa. Also at a pressure higher than this, the same effect can be attained. In the case of depressurization, the pressure may be 90 kPa or less. More effects can be attained when the pressure is set to 50 kPa or less. Higher effects can be exerted preferably at 30 kPa or less and more preferably at 20 kPa or less.

The method carried out after separately carrying out this enzyme impregnation step and then transferring the food ingredient to a canning or bottling vessel is characterized in that secondary materials can be each added at the time of the sealing, which secondary materials include seasonings different from enzyme liquid seasonings that are desirable to be impregnated to the food ingredient, and thickeners. That makes flavoring and adjustment of thickness and hardness easier. In particular, it is effective for addition of thickeners. Although the thickener has effects as a buffer material for the food ingredient in the hard vessel, its enzyme penetration property upon enzyme impregnation may in some cases be interfered because of its viscosity.

In this step, also available is a method using ungelatinizated thickeners at the time of enzyme impregnation; and there is an aspect of easier production because the thickener can be dissolved in water or the like and then added in a thickened state after the enzyme impregnation step or the enzymatic reaction step. Conditions for increasing temperature is the same as those in the method comprising carrying out all of the steps in the hard vessel; and it is necessary to set a target level of softening and increase the temperature while progress of the enzymatic reaction is monitored. Note that the step of filling the food ingredients that have separately processed by depressurization or pressurization in the hard vessel is required in the above step. In view of this, the food ingredients and enzyme liquid seasonings can in advance be filled in the vessel and, while not sealed, separately subjected to the enzyme impregnation processing, followed by carrying out the above enzymatic reaction step and the steps after that.

For the purpose of producing food products that are identical in appearance as usual food ingredients, it is preferred that the hardness suitable for food products for the elderly or persons having difficulty in chewing and swallowing after sterilization and production of hard vessel products be adjusted to, as measurement results of breaking strength by a creepmeter (manufactured by Yamaden Co., Ltd., RE2-33005B), preferably 1.0×10² N/m² or more and 1.0×10⁷ N/m² or less, more preferably 1.0×10³ N/m² or more and 1.0×10⁶ N/m² or less, and still more preferably 1.0×10³ N/m² or more and 1.0×10⁴ N/m² or less. It can be applied to baby foods as well. The edible portions of the food ingredient are softened by the enzymes and the bones are softened by retort (processing by applying pressure and heating). Thus, although the product is for the elderly or persons with difficulty in chewing and swallowing, even the bones of fish and shellfish can be eaten.

### EXAMPLES

Next, the present invention will be described in detail by way of the examples; but the technical scope of the present invention is not limited to these examples.

### Example 1

Bamboo shoot and carrot that had been cut into a thickness of 5 mm and a size of 20 mm×20 mm, and lotus root and burdock that had been cut into a thickness of 5 mm were boiled in boiling water added with vitamin C at 0.1% for 10 minutes. Chicken thigh was cut into a bite size such that its fibers were cut off was used as was. To a tin can, the food ingredients, an enzyme (Orienzyme manufactured by HBI Enzymes Inc., 0.3% by mass), Papain W-40 manufactured by Amano Enzyme Inc., 0.3% by mass), and an aqueous solution prepared by dissolving a small amount of each of amino acid seasoning, dietary sodium chloride, sugar, mirin sweet rice wine, and soy sauce (viscosity measured at 20° C. by a B type rotational viscometer: 3 mPa·s) were added and subjected to double seam sealing. The resultant was then heated to 60° C. at a rate of 0.5° C./min using a steam convection oven (manufactured by Sanyo Electric Co., Ltd., SOB-VS10), After kept at 60° C. for 10 minutes, the resultant was rapidly heated to 124° C. using an autoclave (Autoclave SR-240 manufactured by Tomy Seiko Co., Ltd.). The hardness of the obtained food ingredient was measured (breaking strength, using a creepmeter RE2-33005B manufactured by Yamaden Co., Ltd.); and, as a result, the hardness was found to be 5×10⁴ N/m² or less and the resulting product was sufficiently soft as a food product for persons having difficulty in chewing. The thus obtained product was a canned food product with its original shape being retained and having a good flavor, which food product was easy to eat for persons in need of care. Note that, when shaken, the food ingredient was easy to slightly lose its shape because the liquid seasoning is short of viscosity.

### Example 2 (Comparative)

Bamboo shoot and carrot that had been cut into a thickness of 5 mm and a size of 20 mm×20 mm, and lotus root and burdock that had been cut into a thickness of 5 mm were boiled in boiling water added with vitamin C at 0.1% for 10 minutes. Chicken thigh was cut into a bite size such that its fibers were cut off was used as was. In a retort pouch, the food ingredients, enzymes (Orienzyme manufactured by HBI Enzymes Inc., 0.3% by mass, Papain W-40 manufactured by Amano Enzyme Inc., 0.3% by mass), and an aqueous solution prepared by dissolving a small amount of each of amino acid seasoning, dietary sodium chloride, sugar, mirin sweet rice wine, and soy sauce (viscosity measured at 20° C. by a B type rotational viscometer: 3 mPa·s) were placed and sealed. The resultant was then heated to 60° C. at a rate of 0.5° C./min using a steam convection oven (manufactured by Sanyo Electric Co., Ltd., SOB-VS10). After kept at 60° C. for 10 minutes, the resultant was rapidly heated to 124° C. using an autoclave (Autoclave SR-240 manufactured by Tomy Seiko Co., Ltd.). The hardness of the obtained food ingredient was measured (breaking strength, using a creepmeter RE2-33005B manufactured by Yamaden Co., Ltd.); and, as a result, the hardness was found to be 5×10⁴ N/m² or less and the resulting product was sufficiently soft as a food product for persons having difficulty in chewing. The thus obtained product was a retort pouch food product with its original shape being retained and having a good flavor, which food product was easy to eat for persons in need of care. Note that, when pressed with a finger or shaken, the food ingredient lost its shape.

### Example 3

Lotus root, squid, sato-imo potato, carrot, chicken, and pork that have been cut into a thickness of 10 mm and a bite size were heated at 95° C. using a steam convection oven (manufactured by Sanyo Electric Co., Ltd., SOB-VS10). Thereafter, the food ingredients, 1.0% by mass enzymes (hemicellulase “Amano” 90 and papain (manufactured by Amano Enzyme Inc.)), and an aqueous solution prepared by dissolving commercially available seasoning (2%), a pH adjuster (citric acid 0.1% and sodium salt thereof 0.8%), dietary sodium chloride (2%) (viscosity measured at 20° C. by a B type rotational viscometer: 3 mPa·s) was placed in a tin can; and the resultant was put on a tray in a vacuum packaging machine (V-280A manufactured by TOSEI Corporation) and subjected to depressurization (degree of vacuum 95%, five minutes). The canned product was brought back to ordinary pressure, added with a 5% by mass modified starch aqueous solution, and then sealed (at this point in time, viscosity measured at 20° C. by a B type rotational viscometer: 900 mPa·s), followed by rapid heating to 124° C. using an autoclave (Autoclave SR-240 manufactured by Tomy Seiko Co., Ltd.). The hardness of the obtained food ingredient was measured (breaking strength using a creepmeter RE2-33005B); and, as a result, the hardness was found to be 5×10⁴ N/m² or less and the resulting product was sufficiently soft as a food product for persons having difficulty in chewing. The thus obtained product was a food product for normal temperature distribution with its original shape being retained and having a good flavor, which food product was easy to eat for persons in need of care. Vibration did not cause to lose shape.

### Example 4

String bean, spinach, soybean, and red sea bream bone-in fillet were cut into a bite size. The food ingredients, enzymes (Macerozyme2A, manufactured by Yakult Pharmaceutical Industry Co., Ltd. 0.3% by mass, Papain W-40 manufactured by Amano Enzyme Inc., 0.3% by mass), and an aqueous solution prepared by dissolving a small amount of each of amino acid seasoning, dietary sodium chloride, sugar, mirin sweet rice wine, soy sauce, and curdlan (viscosity measured at 20° C. by a B type rotational viscometer: 1000 mPa·s) were added; and two drops of liquid nitrogen were added to the resultant canned in a tin can and sealed. The resultant was then heated to 60° C. at a rate of 0.5° C./min using a steam convection oven (manufactured by Sanyo Electric Co., Ltd., SOB-VS10). After kept at 60° C. for 10 minutes, the resultant was rapidly heated to 124° C. using an autoclave (Autoclave SR-240 manufactured by Tomy Seiko Co., Ltd.). The hardness of the obtained food ingredient was measured (breaking strength using a creepmeter RE2-33005B manufactured by Yamaden Co., Ltd.); and, as a result, the hardness was found to be 5×10⁴ N/m² or less and the resulting product was sufficiently soft as a food product for persons having difficulty in chewing. Thereafter, a thickener prepared by dissolving SunusWell Alpha (thickening agent, manufactured by Nihon Starch Co., Ltd.) was added and then subjected to sample tasting. The bones of red sea bream was tenderly softened and thus the obtained product was a food product for normal temperature distribution with its original shape being unchanged and having a good flavor, which food product was easy to eat for persons in need of care. Vibration did not cause to lose shape.

### Example 5 (Comparative)

String bean, spinach, soybean, and red sea bream bone-in fillet were cut into a bite size. The food ingredients, enzymes (Macerozyme2A, manufactured by Yakult Pharmaceutical Industry Co., Ltd. 0.3% by mass, Papain W-40 manufactured by Amano Enzyme Inc., 0.3% by mass), and an aqueous solution prepared by dissolving a small amount of each of amino acid seasoning, dietary sodium chloride, sugar, mirin sweet rice wine, soy sauce, and curdlan (viscosity measured at 20° C. by a B type rotational viscometer: 1000 mPa·s) were added and sealed in a retort pouch. The resultant was then heated to 60° C. at a rate of 0.5° C./min using a steam convection oven (manufactured by Sanyo Electric Co., Ltd., SOB-VS10). After kept at 60° C. for 10 minutes, the resultant was rapidly heated to 124° C. using an autoclave (Autoclave SR-240 manufactured by Tomy Seiko Co., Ltd.). The hardness of the obtained food ingredient was measured (breaking strength using a creepmeter RE2-33005B manufactured by Yamaden Co., Ltd.); and, as a result, the hardness was found to be 5×10⁴ N/m² or less and the resulting product was sufficiently soft as a food product for persons having difficulty in chewing. The bones of red sea bream was tenderly softened and thus the obtained product was a food product for normal temperature distribution with its original shape being unchanged and having a good flavor, which food product was easy to eat for persons in need of care. However, when the product was piled up and left in a cardboard box for one hour and then the food ingredient in the retort pouch was observed, the food ingredient was partially disintegrated.

### Example 6

Squid (with the skin being peeled off), octopus (1 cm in thickness), and sato-imo potato were heated with boiling water for 10 minutes. A meat tenderizer (Rizer MODEL H manufactured by Jaccard) was in advance used for the squid and octopus. Thereafter, the food ingredient was immersed in an enzyme liquid prepared by dissolving 0.5% by mass enzymes (pectolyase (Shinnihon Chemicals Corporation) and papain (manufactured by Amano Enzyme Inc.)), one teaspoon commercially available seasonings, emulsified fats and oils (30%), and dietary sodium chloride (1%) in water and adjusted to pH 6.0 with a citric acid buffer for five minutes. Thereafter, the food ingredient and an aqueous solution containing curdlan, agar, and trehalose (viscosity measured at 20° C. by a B type rotational viscometer: 800 mPa·s) was placed in a tin can; and the resultant was put on a tray in a vacuum packaging machine (V-280A manufactured by TOSEI Corporation) and subjected to depressurization (degree of vacuum 95%, five minutes). The canned product was brought back to ordinary pressure and sealed, followed by rapid heating to 124° C. using an autoclave manufactured by Yamaden Co., Ltd., Autoclave SR-240 manufactured by Tomy Seiko Co., Ltd.). The hardness of the obtained food ingredient was measured (breaking strength using a creepmeter RE2-33005B); and, as a result, the hardness was found to be 5×10⁴ N/m² or less and the resulting product was sufficiently soft as a food product for persons having difficulty in chewing. The thus obtained product was a food product for normal temperature distribution with its original shape being retained and having a good flavor, which food product was easy to eat for persons in need of care. Vibration did not cause to lose shape.

### Example 7

Bone-in mackerel was immersed in an enzyme liquid prepared by dissolving curdlan, one teaspoon soy sauce, one teaspoon seasoning, starch, 0.5% by mass enzyme (papain, manufactured by Amano Enzyme Inc.), emulsified fats and oils (30%), dietary sodium chloride (1%) in water, and adjusted to pH 6.0 with a citric acid buffer (viscosity measured at 20° C. by a B type rotational viscometer: 700 mPa·s) for five minutes. Thereafter, the food ingredient, the enzyme liquid, and a small amount of seasoned jellied fish broth were placed in a tin can, subjected to double seam sealing, and heated to 55° C. at a rate of 0.5° C./min using a steam convection oven (manufactured by Sanyo Electric Co., Ltd., SOB-VS10). After kept at 55° C. for 20 minutes, the resultant was rapidly heated to 124° C. using an autoclave (Autoclave SR-240 manufactured by Tomy Seiko Co., Ltd.) and kept for 20 minutes. The hardness of the obtained food ingredient was measured (breaking strength, using a creepmeter RE2-33005B); and, as a result, the hardness was found to be 5×10⁴ N/m² or less and the resulting product was sufficiently soft as a food product for persons having difficulty in chewing. The thus obtained product kept its shape unchanged and had a good flavor; and the bones of the mackerel were softened as well. The obtained product was a food product for normal temperature distribution, which food product was easy to eat for persons in need of care. Vibration did not cause to lose shape.

### Example 8

Bone-in mackerel, carrot, and burdock were immersed in an enzyme liquid prepared by dissolving one teaspoon soy sauce, one teaspoon seasoning, 0.05% by mass enzymes (papain, manufactured by Amano Enzyme Inc., pectinase, manufactured by Shinnihon Chemicals Corporation), dietary sodium chloride (1%) in water, adjusted to pH 6.0 with a citric acid buffer, and added with gelling agar (half amount of the food ingredient) (viscosity measured at 20° C. by a B type rotational viscometer: 5 mPa·s) for five minutes. Thereafter, the resultant was placed in a tin can and subjected to double seam sealing, followed by depressurization at a degree of vacuum of 95% for two minutes. The resultant was heated to 55° C. at a rate of 0.5° C./min using a steam convection oven (manufactured by Sanyo Electric Co., Ltd., SOB-VS10). After kept at 55° C. for 50 minutes, the resultant was rapidly heated to 124° C. using an autoclave (Autoclave SR-240 manufactured by Tomy Seiko Co., Ltd.) and kept for 20 minutes. The hardness of the obtained food ingredient was measured (breaking strength using a creepmeter RE2-33005B); and, as a result, the hardness was found to be 5×10⁴ N/m² or less and the resulting product was sufficiently soft as a food product for persons having difficulty in chewing. At this point in time, the viscosity of the liquid in the tin can measured at 20° C. by a B type rotational viscometer was 800 mPa·s. The thus obtained product kept its shape unchanged and had a good flavor; and the bones of the mackerel were softened as well. The obtained product was a food product for normal temperature distribution, which food product was easy to eat for persons in need of care. Vibration did not cause to lose shape.

### Example 9

Bite-sized whale meat that had a core temperature of 4° C. immediately after thawed and a dispersion liquid of seasoning, citric acid, enzyme (Bromelain F, manufactured by Amano Enzyme Inc.), 0.2% by mass modified starch (viscosity measured at 20° C. by a B type rotational viscometer: 2 mPa·s) were placed in a bottle vessel and subjected to depressurization (degree of vacuum 95%, five minutes) using a vacuum packaging machine (V-280A manufactured by TOSEI Corporation). The bottle was sealed with a metallic lid and subjected to rapid heating to 40° C. at a rate of 2° C./min using a steam convection oven (manufactured by Sanyo Electric Co., Ltd., SOB-VS10). After kept at 40° C. for 20 minutes, the resultant was rapidly heated to 110° C. using an autoclave (Autoclave SR-240 manufactured by Tomy Seiko Co., Ltd.) and kept for 20 minutes. The hardness of the obtained food ingredient was measured (breaking strength using a creepmeter RE2-33005B manufactured by Yamaden Co., Ltd.); and, as a result, the hardness was found to be 5×10⁴ N/m² or less; and the resulting product was sufficiently soft as a food product for persons having difficulty in chewing. At this point in time, the viscosity of the liquid in the bottle vessel measured at 20° C. by a B type rotational viscometer was 500 mPa·s. Vibration did not cause to lose shape.

### Example 10

Daikon white radish that had been cut into a thickness of 5 mm and a size of 20 mm×20 mm, yellowtail, and frozen prawn were placed in a refrigerator at 3° C. and the temperature was adjusted for 10 minutes. To an aqueous solution prepared by dissolving enzyme (0.3% by mass Macerozyme 2A, manufactured by Yakult Pharmaceutical Industry Co., Ltd., 0.3% by mass Bromelain, manufactured by Amano Enzyme Inc.), a small amount of each of amino acid seasoning, dietary sodium chloride, sugar, mirin sweet rice wine, and soy sauce, a contrast agent (Visipaque, manufactured by Daiichi Sankyo Company, Limited) was added so as to be 30% to prepare a contrast agent-containing liquid (viscosity measured by a B type rotational viscometer: 5 mPa·s), which was placed in a tin can and, before sealed, subjected to depressurization at a degree of vacuum of 90% for five minutes. The resultant was added with a thickener prepared by dissolving 0.1% by mass each of xanthane gum and agar and subjected to double seam sealing. The resultant was then heated to 55° C. at a rate of 0.5° C./min using a steam convection oven (manufactured by Sanyo Electric Co., Ltd., SOB-VS10). After kept at 55° C. for 10 minutes, the resultant was rapidly heated to 124° C. using an autoclave (Autoclave SR-240 manufactured by Tomy Seiko Co., Ltd.). The hardness of the obtained food ingredient was measured (breaking strength using a creepmeter RE2-33005B); and, as a result, the hardness was found to be 5×10⁴ N/m² or less and a sufficiently soft, shape-retaining diet for digestive tract contrast imaging examination was able to be prepared. Vibration did not cause to lose shape.

### Example 11

Bamboo shoot and carrot that had been cut into a thickness of 5 mm and a size of 20 mm×20 mm, and lotus root and burdock that had been cut into a thickness of 5 mm were boiled in boiling water added with vitamin C at 0.1% for 10 minutes. Chicken thigh was cut into a bite size such that its fibers were cut off was used as was. To a tin can, the food ingredients, enzymes (0.2% by mass Orienzyme HP manufactured by HBI Enzymes Inc., 0.2% by mass Papain W-40 manufactured by Amano Enzyme Inc.)), and an aqueous solution prepared by dissolving a small amount of each of amino acid seasoning, dietary sodium chloride, sugar, mirin sweet rice wine, soy sauce and sodium bicarbonate (viscosity measured at 20° C. by a B type rotational viscometer: 5 mPa·s) were added and subjected to double seam sealing while degassing. The resultant was then heated to 60° C. at a rate of 0.5° C./min using a steam convection oven (manufactured by Sanyo Electric Co., Ltd., SOB-VS10). After kept at 60° C. for 10 minutes, the resultant was rapidly heated to 124° C. using an autoclave (Autoclave SR-240 manufactured by Tomy Seiko Co., Ltd.). The hardness of the obtained food ingredient was measured (breaking strength using a creepmeter RE2-33005B manufactured by Yamaden Co., Ltd.); and, as a result, the hardness was found to be 5×10⁴ N/m² or less; and the resulting product was sufficiently soft as a food product for persons having difficulty in chewing. In order to prevent losing shape due to vibration, it was necessary to use special containers for transportation. When a thickener prepared by dissolving potato starch was added at the time of eating, the obtained product became a canned food product keeping its shape unchanged and having a good flavor, which canned food product was easy to eat for persons in need of care.

### Example 12

Commercially available raw beef was cut into a size of 15 mm×15 mm×15 mm and frozen at −15° C. Subsequently, to a bottle vessel, an aqueous solution containing 1% by mass trehalose, 33% by mass contrast agent (trade name: Visipaque270), Papain W-40 (0.5% by mass), 0.05% by mass modified starch, and 0.1% by mass curdlan ((viscosity measured at 20° C. by a B type rotational viscometer: 20 mPa·s) and the beef were placed and immersed to thaw at room temperature for 10 minutes. After degassed and sealed, the bottle was heated at a rate of 0.2° C./min to an achieving temperature of 60° C. in hot water, followed by autoclave sterilization for 30 minutes by heating to 118° C. using an autoclave (Autoclave SR-240 manufactured by Tomy Seiko Co., Ltd.) to obtain a shape-retaining softened diet for medical examination. After cooled, the bottle was opened. When the food ingredient was subjected to sensory evaluation and observation with X-ray microscope (XGT-5000, manufactured by Horiba, Ltd.), the food had softness that enabled even persons having difficulty in swallowing to eat; and the contrast agent was uniformly impregnated. Vibration did not cause to lose shape.

### Example 13

Lotus root, squid, sato-imo potato, carrot, chicken, and pork that have been cut into a thickness of 10 mm and a bite size were heated at 95° C. using a steam convection oven (manufactured by Sanyo Electric Co., Ltd., SOB-VS10). Thereafter, the food ingredient, 1.0% by mass enzyme (hemicellulase “Amano” 90 and papain (manufactured by Amano Enzyme Inc.)), and an aqueous solution prepared by dissolving commercially available seasoning (2%), a pH adjuster (citric acid 0.1% and sodium salt thereof 0.8%), dietary sodium chloride (2%) was placed in a heat resistant formed vessel; and the resultant was put on a tray in a vacuum packaging machine (V-280A manufactured by TOSEI Corporation) and subjected to depressurization (degree of vacuum 95%, five minutes). The resultant was brought back to ordinary pressure, added with an aqueous solution containing 0.1% by mass each of modified starch, agar, gelatin, and xanthane gum (viscosity measured by a B type rotational viscometer: 1 Pa·s), and then sealed by thermocompression bonding with a film having polyethylene-aluminum as a major constituting component, followed by heating at 95° C. for 30 minutes using an autoclave (Autoclave SR-240 manufactured by Tomy Seiko Co., Ltd.) to produce a chilled food product. The hardness of the obtained food ingredient was measured (breaking strength using a creepmeter RE2-33005B); and, as a result, the hardness was found to be 5×10⁴ N/m² or less and the resulting product was sufficiently soft as a food product for persons having difficulty in chewing. The thus obtained product was a food product for normal temperature distribution with its original shape being retained and having a good flavor, which food product was easy to eat for persons in need of care. Vibration did not cause to lose shape.

1. A food product packaged in a hard vessel for normal temperature distribution or chilled distribution comprising:
a hard vessel;
a food ingredient, a degradative enzyme, and a liquid seasoning housed in the hard vessel;
wherein the food product is obtained by reacting the food ingredient with the degradative enzyme inside the hard vessel to soften the food ingredient while retaining an original shape.

2. The food product packaged in a hard vessel according to claim 1, wherein the degradative enzyme has an enzyme activity breaking down at least one kind of substrate selected from the group consisting of: carbohydrates, proteins and lipids.

3. The food product packaged in a hard vessel according to claim 1, wherein the hardness of softened food ingredient while retaining an original shape is 1.0×10² N/m² or more and 1.0×10⁷ N/m² or less.

4. The food product packaged in a hard vessel according to claim 1, wherein the viscosity of liquid in the hard vessel is, when measured by a B type viscometer at 20° C., 5 mPa·s or more and 20 Pa·s or less in a sol state with fluidity or in a gel state.

5. The food product packaged in a hard vessel according to claim 1, wherein the liquid seasoning contains at least one kind selected from the group consisting of: dietary sodium chloride, amino acids, fats and oils, thickeners, medical contrast agents, sugars, sodium hydrogen carbonate, vitamins and minerals.

6. The food product packaged in a hard vessel according to claim 1, wherein the liquid seasoning is adjusted to a range of pH 3 to pH 10 by using an organic acid and a salt thereof.

7. The food product packaged in a hard vessel according to claim 1, wherein the hard vessel is at least one kind selected from the group consisting of: metallic cans, bottles, and heat resistant formed vessels.

8. A method of producing a food product packaged in a hard vessel for normal temperature distribution or chilled distribution in which a softened food ingredient while retaining an original shape is housed, the method comprising the steps of:
adding a food ingredient and a degradative enzyme-containing liquid into a hard vessel;
sealing the hard vessel;
increasing a temperature in the hard vessel after the sealing;
wherein an enzymatic reaction step, an enzyme deactivation step and a sterilization step are carried out inside the hard vessel under a series of temperature increase.

9. A method of producing a food product packaged in a hard vessel for normal temperature distribution or chilled distribution in which a softened food ingredient while retaining an original shape is housed, the method comprising the steps of:
reacting a food ingredient with a degradative enzyme;
adding the food ingredient reacted with the degradative enzyme in a hard vessel;
increasing a temperature in the hard vessel;
wherein an enzymatic reaction step, an enzyme deactivation step and a sterilization step are carried out inside the hard vessel under a series of temperature increase.

10. The method of producing a food product packaged in a hard vessel according to claim 8, a temperature of the enzymatic reaction step is in a range of 0° C. to 70° C. and a temperature of the sterilization step is in a range of 85° C. to 135° C.

11. The method of producing a food product packaged in a hard vessel according to claim 9, wherein the hard vessel is sealed before the enzymatic reaction step or before the enzyme deactivation.

12. The method of producing a food product packaged in a hard vessel according to claim 11, wherein pressurization processing or depressurization processing for the food ingredient is carried out before the sealing step of the hard vessel.

13. The method of producing a food product packaged in a hard vessel according to claim 8, wherein the degradative enzyme has an enzyme activity of breaking down at least one kind of substrate selected from the group consisting of: carbohydrates, proteins and lipids.

14. The method of producing a food product packaged in a hard vessel according to claim 8, wherein a liquid seasoning is added into the hard vessel before the hard vessel is sealed.

15. The method of producing a food product packaged in a hard vessel according to claim 14, wherein the viscosity of liquid in the hard vessel after the sterilization step has, when measured by a B type viscometer at 20° C., 5 mPa·s or more and 20 Pa·s or less in a sol state with fluidity or in a gel state.

16. The method of producing a food product packaged in a hard vessel according to claim 14, wherein the liquid seasoning contains at least one kind selected from the group consisting of: dietary sodium chloride, amino acids, fats and oils, thickeners, medical contrast agents, sugars, sodium hydrogen carbonate, vitamins and minerals.

17. The method of producing a food product packaged in a hard vessel according to claim 14, wherein the liquid seasoning is adjusted to a range of pH 3 to pH 10 by using an organic acid and a salt thereof.

18. The method of producing a food product packaged in a hard vessel according to claim 8, wherein pressure inside of the hard vessel after the sealing is changed by, before the sealing of the hard vessel, adding a gas component in a liquid or gaseous state to increase pressure in the hard vessel after the sealing, or by degassing air in the hard vessel to reduce pressure in the hard vessel after the sealing.

19. The method of producing a food product packaged in a hard vessel according to claim 8, wherein the hardness of the softened food ingredient while retaining an original shape is 1.0×10² N/m² or more and 1.0×10⁷ N/m² or less.

20. The method of producing a food product packaged in a hard vessel according to claim 8, wherein the hard vessel is at least one kind selected from the group consisting of: metallic cans, bottles, and heat resistant formed vessels.
